(19) United States
(12) Patent Application Publication
(10) Pub. No.: US 2026/0244879 A1
(43) Pub. Date: Aug. 20, 2026

(54) INFORMATION PROCESSING APPARATUS, INFORMATION PROCESSING SYSTEM, AND INFORMATION PROCESSING METHOD

(71) Applicant: Kioxia Corporation, Tokyo (JP)

(72) Inventor: Takashi TOI, Yokohama Kanagawa (JP)

(73) Assignee: Kioxia Corporation, Tokyo (JP)

(21) Appl. No.: 19/241,701

(22) Filed: Jun. 18, 2025

(30) Foreign Application Priority Data
Feb. 14, 2025 (JP) 2025-022803

(51) Int. Cl. G06F 40/40; G06F 40/284; G06F 40/295

(52) U.S. Cl. CPC G06F 40/40; G06F 40/284; G06F 40/295

(57) ABSTRACT

An information processing apparatus has a storage device that stores a learning target model including a first embedding layer that converts an input token string into an embedded representation, a transformer layer that performs processing based on the embedded representation, and a second embedding layer that linearly converts an output of the transformer layer; and a control device initializes the first and second embedding layers, performs second pre-training, alternately repeats initialization of the first and second embedding layers and the second pre-training until it is determined that the second pre-training satisfies an end condition, and fixes weight parameters of the transformer layer when determined that the end condition is satisfied, and input a text not including named entities to the learning target model in a state where the first embedding layer and the second embedding layer are initialized to perform third pre-training.

### CROSS REFERENCE TO RELATED APPLICATIONS

This application is based upon and claims the benefit of priority from the prior Japanese Patent Application No. 2025-022803, filed on Feb. 14, 2025, the entire contents of which are incorporated herein by reference.

### FIELD

An embodiment of the present invention relates to an information processing apparatus, an information processing system, and an information processing method.

### BACKGROUND

A large language model (LLM) configured using enormous learning data and an advanced deep learning technology attracts attention. LLM has excellent language ability and static internal knowledge (general-purpose information) acquired by pre-training, but cannot basically utilize dynamic external knowledge (non-general-purpose information) such as information (for example, internal rules) used in a specific organization or the like or latest information. Therefore, a retrieval augmented generation (RAG) system that registers the dynamic external knowledge in a database (hereinafter, external DB) separate from the LLM, gives information obtained by searching the external DB to the LLM as a part of a prompt, and generates an output is widespread in a wide range of applications.

However, a knowledge collision in which the external knowledge obtained from the external DB and the internal knowledge of the LLM are contradictory may occur. If a knowledge collision occurs, the reliability of the output of the LLM is reduced.

### BRIEF DESCRIPTION OF THE DRAWINGS

FIG. 1 is a block diagram illustrating a schematic configuration of an information processing apparatus according to an embodiment.

FIG. 2 is a diagram illustrating a schematic configuration of a learning target model used in the present embodiment.

FIG. 3 is a diagram illustrating a schematic configuration of an encoder-decoder model.

FIG. 4 is a flowchart illustrating a processing operation of the information processing apparatus according to the present embodiment.

FIG. 5 is a block diagram illustrating a schematic configuration of an information processing system including a pre-trained model, an external DB, and a retriever.

FIG. 6 is a diagram illustrating an output example in a case where any question is input to the information processing system of FIG. 5.

FIG. 7 is a diagram illustrating an output example in a case where the same question as that in FIG. 5 is input to a pre-trained model according to a comparative example.

### DETAILED DESCRIPTION

An information processing apparatus according to an embodiment includes:
a storage device that is capable of storing a learning target model including a first embedding layer configured to convert an input token string into an embedded representation, a transformer layer configured to perform processing based on the embedded representation by using weight parameters, and a second embedding layer configured to linearly convert an output of the transformer layer; and
a control device configured to:
initialize the first embedding layer and the second embedding layer after first pre-training in which learning is performed by inputting a text including named entities to the learning target model;
perform second pre-training by inputting a text including named entities to the learning target model after the initialization;
alternately repeat initialization of the first embedding layer and the second embedding layer and the second pre-training until it is determined that the second pre-training satisfies an end condition; and
fix the weight parameters of the transformer layer when it is determined that the end condition is satisfied, and input a text not including named entities to the learning target model in a state where the first embedding layer and the second embedding layer are initialized to perform third pre-training.

Hereinafter, embodiments of an information processing apparatus, an information processing system, and an information processing method are described with reference to the drawings. Hereinafter, main components of the information processing apparatus are mainly described below, but the information processing apparatus may have components and functions that are not illustrated or described. The following description does not exclude components and functions that are not illustrated or described.

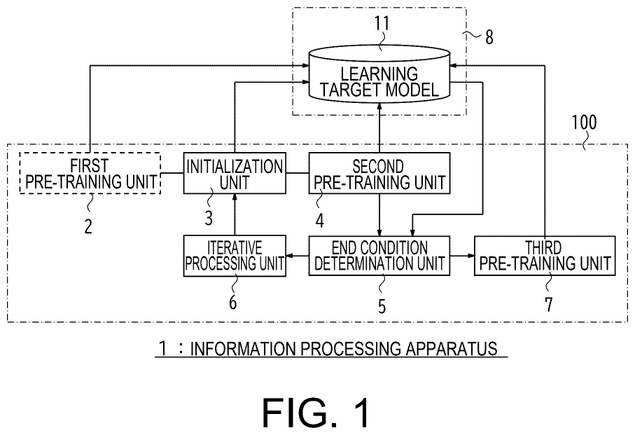

FIG. 1 is a block diagram illustrating a schematic configuration of an information processing apparatus 1 according to an embodiment. The information processing apparatus 1 according to the embodiment is configured with, for example, a general-purpose computer. As described below, at least some functions of the information processing apparatus 1 according to the embodiment can be implemented by hardware or software. When at least some functions of the information processing apparatus 1 are implemented by software, the computer executes a program in which at least some functions of the information processing apparatus 1 are described, thereby executing at least some functions of the information processing apparatus 1.

The information processing apparatus 1 illustrated in FIG. 1 has a function of learning a large language model (LLM). In the present specification, an LLM to be pre-trained may be referred to as a learning target model 11, and a pre-trained LLM may be referred to as a pre-trained model. When a question is given to the pre-trained model, the pre-trained model returns an answer to the question or generates a new sentence or image in accordance with the question. In FIG. 1, the pre-trained model is not illustrated. Note that, in the present specification, generation of a new sentence, image, or the like by LLM according to an input question may also be referred to as an answer.

Before the configuration and operation of the information processing apparatus 1 according to the embodiment is described, the configuration of the learning target model 11 used in a present embodiment is described.

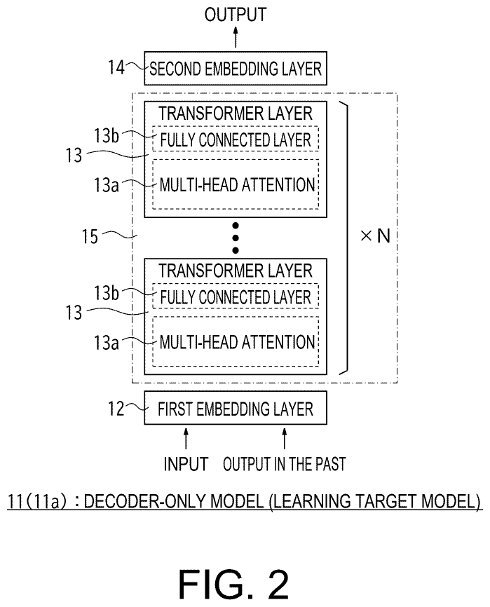

FIG. 2 is a diagram illustrating a schematic configuration of the learning target model 11 used in the present embodiment. For example, a text including a term used on a daily basis can be input to the learning target model 11 in FIG. 2 as a tokenized token string. The learning target model 11 illustrated in FIG. 2 includes a first embedding layer 12, N (N is an integer of one or more) transformer layers 13, and a second embedding layer 14.

The first embedding layer 12 converts the input token string into an embedded representation. The token string includes a plurality of tokens. In the present specification, the embedded representation is an expression obtained by vectorizing the token string, that is, data representing a vector.

The N transformer layers 13 configure a transformer block 15 and perform, for example, arithmetic processing for generating a new text or sentence according to an input text using weight parameters. Hereinafter, a text or a sentence is simply referred to as a text. When N is 2 or more, the individual transformer layers 13 are connected in series and perform arithmetic processing stepwise.

Each transformer layer 13 has a multi-head attention 13a and a fully connected layer 13b.

The multi-head attention 13a considers the importance of the plurality of input tokens. For example, for each token input to each transformer layer 13, it is calculated how much attention is to be paid to each token output from each transformer layer 13.

Specifically, the following processing is executed in the multi-head attention 13a. By calculating the inner product of the query and the key between the embedded representations of the plurality of input tokens, a score indicating how much each token is associated with another token is calculated. Next, a scaling of the score is then performed to determine how much the embedded representation of each token weights the embedded representations of the other tokens, thereby determining a value of the embedded representation of each token. This means that it is determined how much information the embedded representation of each token receives from the embedded representations of the other tokens.

In the multi-head attention 13a, the processing described above is performed in parallel for each of the plurality of tokens, thereby speeding up the processing. In addition, the multi-head attention 13a of the transformer layer 13 according to the present embodiment performs the above-described calculation only for a word that appears before a word in a text, and thus is called masked self-attention.

The fully connected layer 13b outputs an internal expression obtained by weighting the calculation result output from the multi-head attention 13a. By connecting the plurality of transformer layers 13 in series to configure the transformer block 15, an embedded representation of the token in consideration of the context can be obtained.

The second embedding layer 14 linearly converts the output of the transformer block 15 and outputs a token in accordance with the output probability of each vocabulary. The second embedding layer 14 generally outputs a token having the highest output probability.

The first embedding layer 12 described above can understand the features of the words included in the input text to some extent but does not have a multi-head attention, and thus the context cannot be understood. Meanwhile, the transformer layer 13 has a multi-head attention and thus can have a higher level of language understanding ability in consideration of context for an input token.

Note that not only the token string input from the outside but also the token string (output in the past) output from the second embedding layer 14 is input to the first embedding layer 12. The first embedding layer 12 also converts the token string from the second embedding layer 14 into an embedded representation. That is, the learning target model 11 in FIG. 2 executes learning and inference using an input from the outside and its own output.

The learning target model 11 in FIG. 2 is a decoder-only model 11a having the transformer block 15 functioning as a decoder but not having an encoder. The information processing apparatus 1 according to the present embodiment does not necessarily learn the learning target model 11 of the decoder-only model 11a. The information processing apparatus 1 according to the present embodiment can also perform learning using an encoder-decoder model 11b including the encoder and the transformer block 15 as the learning target model 11.

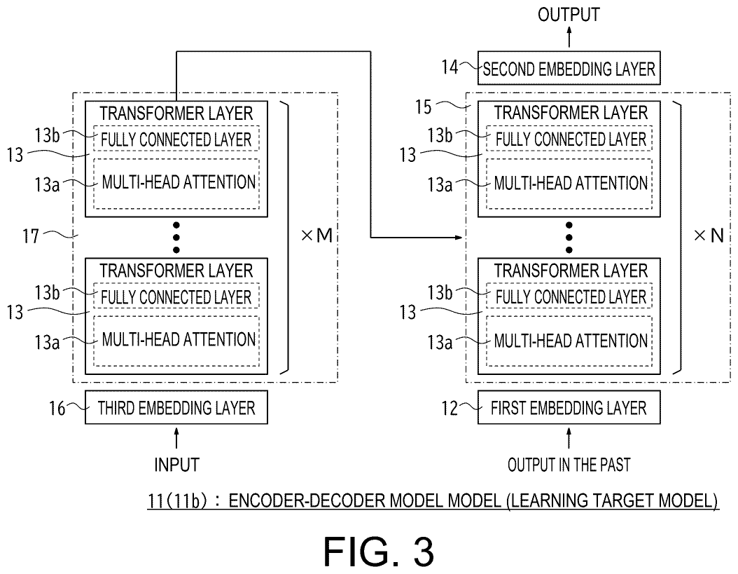

FIG. 3 is a diagram illustrating a schematic configuration of an encoder-decoder model 11b. The encoder-decoder model 11b in FIG. 3 includes a third embedding layer 16 and an encoder 17 in addition to the configuration of the decoder-only model 11a in FIG. 2.

The third embedding layer 16 converts the input token string into an embedded representation. The encoder 17 performs arithmetic processing using the weight parameters on the input embedded representation. The encoder 17 provides the transformer block 15 with the feature amount obtained by the operation. The encoder 17 has M transformer layers 13. The function of each transformer layer 13 of the encoder 17 is equivalent to that of the transformer layer 13 of the transformer block 15. The number M of the transformer layers 13 of the encoder 17 may be the same as or different from the number N of transformer layers 13 of the transformer block 15.

The first embedding layer 12 of the encoder-decoder model 11b does not receive an input from the outside (token string), but the other functions are equivalent to those of the first embedding layer 12 of the decoder-only model 11a. That is, the learning target model 11 in FIG. 3 also executes learning and inference using an input from the outside and its own output.

Hereinafter, a case where the learning target model 11 of the decoder-only model 11a illustrated in FIG. 2 is pre-trained is mainly described. As illustrated in FIG. 1, the information processing apparatus 1 according to the embodiment includes a first pre-training unit 2, an initialization unit 3, a second pre-training unit 4, an end condition determination unit 5, an iterative processing unit 6, a third pre-training unit 7, and a storage unit 8.

The first pre-training unit 2, the initialization unit 3, the second pre-training unit 4, the end condition determination unit 5, the iterative processing unit 6, and the third pre-training unit 7 are functional units implemented by a control device 100. The control device 100 is configured with, for example, a processor such as a central processing unit (CPU) or dedicated hardware. When the control device 100 is a processor, the function is performed by executing a program in which the function of each functional unit described above is described. The control device 100 is also referred to as a controller circuit or a control circuit.

The storage unit 8 is a storage device that can store data in a nonvolatile manner. The storage unit 8 is, for example, a solid state drive (SSD) or a hard disk drive (HDD). In addition, the storage unit 8 may be a storage device that can store data in a volatile manner. In this case, the storage unit 8 is, for example, a dynamic random access memory (DRAM) or a static random access memory (SRAM). The storage unit 8 is also referred to as a storage circuit.

The first pre-training unit 2 performs pre-training by inputting a text including named entities to the learning target model 11. The named entities are, for example, an expression including a unique name indicating a specific object, a human being, or the like and is, for example, a text used on a daily basis. In the present specification, a text including named entities may be referred to as a normal corpus. The pre-training refers to learning performed before performing learning (learning by the second pre-training unit 4 and the third pre-training unit 7) specific to the present embodiment described below. The pre-training by the first pre-training unit 2 may be performed by a device different from the information processing apparatus 1 according to the present embodiment. In this case, the learning target model 11 after completion of pre-training by a device different from the information processing apparatus 1 is input (loaded) to the information processing apparatus 1 according to the present embodiment. The loaded learning target model 11 is stored in the model storage unit 8.

The initialization unit 3 initializes the first embedding layer 12 and the second embedding layer 14 after pre-training by the first pre-training unit 2. By initializing the first embedding layer 12 and the second embedding layer 14, the first embedding layer 12 and the second embedding layer 14 lose knowledge such as a relationship between words included in the normal corpus input in the past.

The second pre-training unit 4 performs pre-training by inputting the normal corpus to the learning target model 11 initialized by the initialization unit 3. The second pre-training unit 4 performs pre-training after initializing the first embedding layer 12 and the second embedding layer 14, whereas the first pre-training unit 2 performs pre-training without initializing the first embedding layer 12 and the second embedding layer 14.

The end condition determination unit 5 determines whether the pre-training by the second pre-training unit 4 satisfies the end condition. The end condition is, for example, that the value of the loss function of the learning target model 11 becomes equal to or less than a predetermined value. In this case, when the value of the loss function becomes equal to or less than the predetermined value, it is determined that the end condition is satisfied. Alternatively, the end condition may be, for example, processing (pre-training) of the second pre-training unit 4 is performed a predetermined number of times. In this case, when the processing of the second pre-training unit 4 is performed a predetermined number of times, it is determined that the end condition is satisfied.

The iterative processing unit 6 alternately repeats the initialization of the first embedding layer 12 and the second embedding layer 14 by the initialization unit 3 and the pre-training by the second pre-training unit 4 until the end condition determination unit 5 determines that the end condition is satisfied. In this manner, the pre-training by the second pre-training unit 4 is repeatedly performed after the initialization by the initialization unit 3 is performed until the end condition is satisfied. By repeatedly performing initialization of the first embedding layer 12 and the second embedding layer 14 and pre-training by the second pre-training unit 4, nonverbal concept knowledge is accumulated in the transformer layer 13.

When the end condition determination unit 5 determines that the end condition is satisfied, the third pre-training unit 7 fixes the weight parameters of the transformer layer 13 and initializes the first embedding layer 12 and the second embedding layer 14. In this state, the third pre-training unit 7 continuously performs pre-training by inputting a text not including named entities to the learning target model 11. In the present specification, a text not including named entities may be simply referred to as a corpus. To fixing the weight parameters means to maintain the same value without updating the weight parameters. The initialization of the first embedding layer 12 and the second embedding layer 14 may be performed by the initialization unit 3.

By performing pre-training by the third pre-training unit 7, the learning target model 11 cannot remember the meaning of the named entities when an input including the named entities are given, and reads the expression as an initial expression. Furthermore, even when the output of the named entities are contextually expected, the learning target model 11 cannot output the named entities.

When the learning target model 11 is the encoder-decoder model 11b illustrated in FIG. 3, the initialization of the first embedding layer 12, the second embedding layer 14, and the third embedding layer 16 by the initialization unit 3 and the pre-training of the transformer layer 13 of each of the encoder 17 and the transformer block 15 by the second pre-training unit 4 are repeatedly performed. Furthermore, when the end condition is satisfied, the first embedding layer 12, the second embedding layer 14, and the third embedding layer 16 are initialized in a state where the weight parameters of the transformer layer 13 of each of the encoder 17 and the transformer block 15 are fixed, and pre-training of the transformer layer 13 of each of the encoder 17 and the transformer block 15 is performed by the third pre-training unit 7.

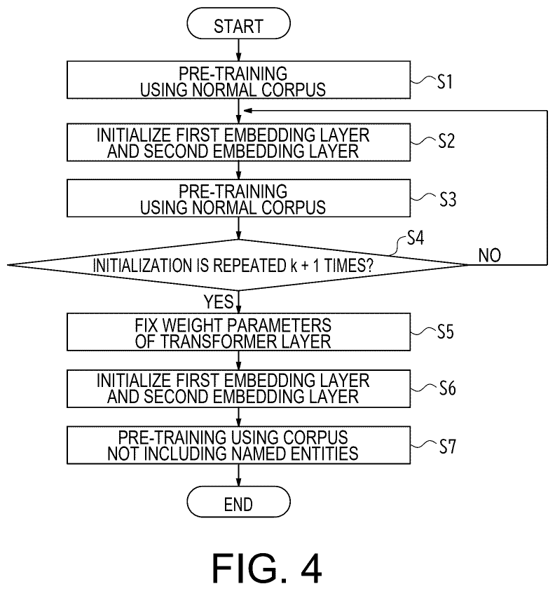

FIG. 4 is a flowchart illustrating a processing operation of the information processing apparatus 1 according to the present embodiment. The flowchart of FIG. 4 is executed, for example, by a computer that configures the information processing apparatus 1.

First, pre-training is performed by inputting a normal corpus including named entities to the learning target model 11 (S1). The processing of S1 is performed by the first pre-training unit 2. As described above, the pre-training by the first pre-training unit 2 may be performed using a device different from the information processing apparatus 1, and the preliminary learned learning target model 11 by another device may be input (loaded) to the information processing apparatus 1.

Next, the first embedding layer 12 and the second embedding layer 14 of the learning target model 11 are initialized (S2). The processing of S2 is performed by the initialization unit 3. With the initialization of S2, the first embedding layer 12 and the second embedding layer 14 lose embedded representations for all vocabularies.

Next, pre-training is performed with the normal corpus including the named entities(S3). The processing of S3 is performed by the second pre-training unit 4. The processing of S3 is repeatedly performed every time the initialization of S2 is performed. As a result, the transformer layer 13 of the learning target model 11 mainly learns nonverbal concept knowledge.

Next, it is determined whether initialization of the first embedding layer 12 and the second embedding layer 14 is repeated a predetermined number of times (for example, k+1 times, k>10) (S4). When S4 is NO, the processing of S2 and subsequent processing are repeated. The processing of S4 is performed by the end condition determination unit 5. As described above, the processing of S4 may be performed using an end condition other than the number of times.

If S4 is YES, the weight parameters of each transformer layer 13 of the learning target model 11 are fixed (S5). Before and after the processing of S5, the first embedding layer 12 and the second embedding layer 14 of the learning target model 11 are initialized (S6). The order of the processing of S5 and S6 is in any order.

Next, pre-training is performed on the learning target model 11 using a corpus not including named entities (S7). The processing of S5 and S7 is performed by the third pre-training unit 7. The processing of S6 is performed by the third pre-training unit 7 or the initialization unit 3.

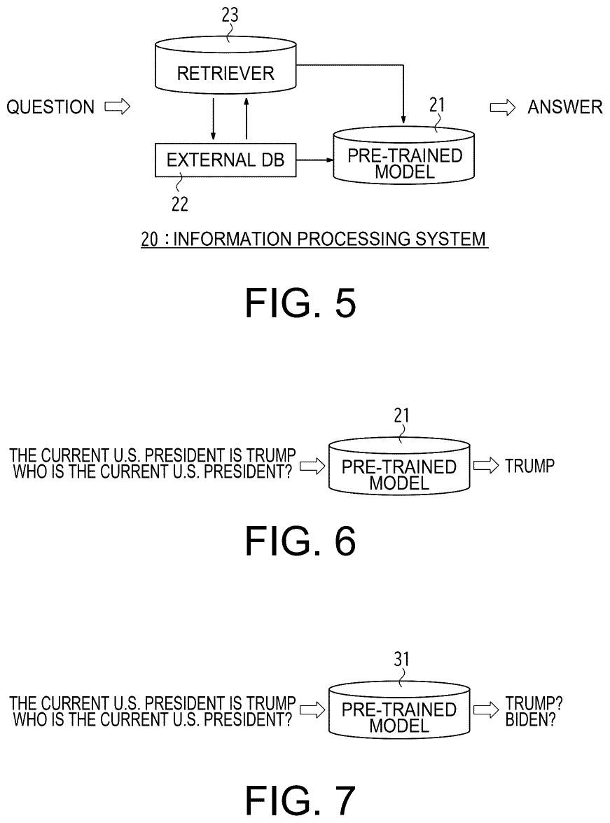

FIG. 5 is a block diagram illustrating a schematic configuration of an information processing system 20 including a pre-trained model (LLM) 21 pre-trained by the processing of FIG. 4, an external DB 22, and a retriever 23. The information processing system 20 outputs an answer to a question from the outside. The pre-trained model 21 mainly accumulates general-purpose information as knowledge. The external DB 22 accumulates, as knowledge, non-general-purpose information mainly used in a specific organization or the like or latest information extracted from the Internet. The external DB 22 is a storage device that stores knowledge that the pre-trained model 21 does not have. The retriever 23 is a model for searching for related information regarding an input question using the external DB 22. The retriever 23 provides a new question based on the question and the search result to the pre-trained model 21.

The question input to the information processing system 20 in FIG. 5 is input to the retriever 23, and the retriever 23 searches the external DB 22 for information related to the question. Then, the retriever 23 inputs the question and the related information extracted from the external DB 22 to the pre-trained model 21. The pre-trained model 21 outputs an answer to the question using the knowledge possessed by itself. That is, the information processing system 20 is a search system using the RAG system.

The information processing system 20 using the pre-trained model 21 pre-trained by the information processing apparatus 1 according to the present embodiment generates an answer based on a search result even if the search result including the named entities output from the external DB 22 contradicts general knowledge (knowledge included in the normal corpus) related to the named entities. As a result, it is possible to avoid a knowledge collision between the external knowledge obtained from the external DB 22 and the internal knowledge possessed by the pre-trained model 21.

FIG. 6 is a diagram illustrating an output example in a case where any question is input to the information processing system 20 of FIG. 5. The question in this example is a question asking general knowledge related to named entities. FIG. 6 illustrates an example of inputting a question of ‘The current U.S. President is Trump. Who is the current U.S. President?’ to the pre-trained model 21. In this case, the pre-trained model 21 outputs a correct answer of “Trump” in a case where the latest information is given as the external knowledge. This is a result of accepting the given external knowledge as it is because the pre-trained model 21 does not have knowledge about the current U.S. president as internal knowledge.

FIG. 7 is a diagram illustrating an output example in a case where the same question as that in FIG. 6 is input to a pre-trained model (LLM) 31 according to a comparative example in which learning is performed using a normal corpus without performing the processing of FIG. 4. In FIG. 7, the pre-trained model 31 has an unstable output between the answer of “Trump” according to the external knowledge and the answer of “Biden” according to the internal knowledge, and it is difficult to predict which one is going to be output. Note that it is assumed that the pre-training data of the pre-trained model 31 includes information of “U.S. President is Biden”.

As described above, in the present embodiment, when the pre-training of the learning target model 11 is repeated by the second pre-training unit 4, the first embedding layer 12 and the second embedding layer 14 are initialized every time the pre-training is performed. As a result, nonverbal concept knowledge is accumulated in the transformer layer 13. Furthermore, when the third pre-training unit 7 performs pre-training of the learning target model 11, a corpus not including the named entities is input, but the weight of the transformer layer 13 is fixed. Therefore, the transformer layer 13 can maintain a state in which a concept of abundant knowledge including the named entities is stored. As a result, even if a question including a normal corpus including named entities is input to the pre-trained model 21 pre-trained using the information processing apparatus 1 according to the present embodiment, the model cannot extract related information from the internal knowledge regarding the named entities, but can read the named entities as an initial expression with reference to the given external information and output an appropriate answer.

At least a portion of the information processing apparatus 1 described in the above-described embodiment may be configured by hardware or may be configured by software. When at least a portion of the information processing apparatus is configured by software, a program for implementing at least some functions of the information processing apparatus 1 may be stored in a recording medium such as a flexible disk or a CD-ROM and may be read and executed by a computer. The recording medium is not limited to a removable recording medium such as a magnetic disk or an optical disk and may be a fixed recording medium such as a hard disk device or a memory.

In addition, the program for implementing at least some functions of the information processing apparatus 1 may be distributed via a communication line (including wireless communication) such as the Internet. Further, the program may be distributed via a wired line or a wireless line such as the Internet or in a manner of being stored in a recording medium in an encrypted, modulated, or compressed state.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An information processing apparatus comprising:
a storage device that is capable of storing a learning target model including a first embedding layer configured to convert an input token string into an embedded representation, a transformer layer configured to perform processing based on the embedded representation by using weight parameters, and a second embedding layer configured to linearly convert an output of the transformer layer; and
a control device configured to:
initialize the first embedding layer and the second embedding layer after first pre-training in which learning is performed by inputting a text including named entities to the learning target model;
perform second pre-training by inputting a text including named entities to the learning target model after the initialization;
alternately repeat initialization of the first embedding layer and the second embedding layer and the second pre-training until it is determined that the second pre-training satisfies an end condition; and
fix the weight parameters of the transformer layer when it is determined that the end condition is satisfied, and input a text not including named entities to the learning target model in a state where the first embedding layer and the second embedding layer are initialized to perform third pre-training.

2. The information processing apparatus according to claim 1,
wherein the transformer layer includes a multi-head attention and a fully connected layer.

3. The information processing apparatus according to claim 1,
wherein the learning target model includes a plurality of the transformer layers connected in series,
the second embedding layer is configured to linearly transform an output of the transformer layer in a final stage, and
the control device is configured to perform the third pre-training in a state where the weight parameters of each of the plurality of transformer layers are fixed, when it is determined that the end condition is satisfied in the third pre-training.

4. The information processing apparatus according to claim 1,
wherein the control device is configured to determine whether the end condition is satisfied based on a magnitude of a loss of the learning target model caused by the second pre-training or a predetermined number of times of the second pre-training.

5. The information processing apparatus according to claim 4,
wherein the control device is configured to determine that the end condition is satisfied when a loss of the learning target model caused by the second pre-training falls below a predetermined value.

6. The information processing apparatus according to claim 1,
wherein the learning target model is a decoder-only model that does not include an encoder and includes a decoder, or an encoder-decoder model that includes the encoder and the decoder.

7. The information processing apparatus according to claim 6,
wherein the learning target model includes the first embedding layer and the transformer layer that are separate from each other for the encoder and the decoder, and
the control device is configured to perform the first pre-training, the second pre-training, and the third pre-training in both the encoder and the decoder in parallel.

8. The information processing apparatus according to claim 1,
wherein, when the text input to the first embedding layer includes a content including named entities after the third pre-training is performed, the learning target model is configured to output an answer according to the content.

9. An information processing system comprising:
an information processing apparatus that includes a first storage device and a control device;
a pre-trained model that is obtained by learning a learning target model by the information processing apparatus; and
a second storage device configured to store latest information not included in learning data of the learning target model or knowledge regarding a specific region,
wherein the first storage device is configured to store a learning target model including a first embedding layer configured to convert an input token string into an embedded representation, a transformer layer configured to perform processing based on the embedded representation by using weight parameters, and a second embedding layer configured to linearly convert an output of the transformer layer,
the control device is configured to:
initialize the first embedding layer and the second embedding layer after first pre-training in which learning is performed by inputting a text including named entities to the learning target model,
perform second pre-training by inputting a text including named entities to the learning target model after the initialization,
alternately repeat initialization of the first embedding layer and the second embedding layer and the second pre-training until it is determined that the second pre-training satisfies an end condition, and
fix the weight parameters of the transformer layer when it is determined that the end condition is satisfied, and input a text not including named entities to the learning target model in a state where the first embedding layer and the second embedding layer are initialized, to perform third pre-training, and
wherein the pre-trained model is configured to use a search result of the second storage device for a question input to the second storage device and output an answer to the question.

10. The information processing system according to claim 9,
wherein the transformer layer includes a multi-head attention and a fully connected layer.

11. The information processing system according to claim 9,
wherein the learning target model includes a plurality of the transformer layers connected in series,
the second embedding layer is configured to linearly transform an output of the transformer layer in a final stage, and
the control device is configured to perform the third pre-training in a state where the weight parameters of each of the plurality of transformer layers are fixed, when it is determined that the end condition is satisfied in the third pre-training.

12. The information processing system according to claim 9,
wherein the control device is configured to determine whether the end condition is satisfied based on a magnitude of a loss of the learning target model caused by the second pre-training or a predetermined number of times of the second pre-training.

13. An information processing method comprising:
storing a learning target model including a first embedding layer configured to convert an input token string into an embedded representation, a transformer layer configured to perform processing based on the embedded representation by using weight parameters, and a second embedding layer configured to linearly convert an output of the transformer layer;
initializing the first embedding layer and the second embedding layer after first pre-training in which learning is performed by inputting a text including named entities to the learning target model;
performing second pre-training by inputting a text including named entities to the learning target model after the initialization;
alternately repeating initialization of the first embedding layer and the second embedding layer and the second pre-training until it is determined that the second pre-training satisfies an end condition; and
fixing the weight parameters of the transformer layer when it is determined that the end condition is satisfied, and inputting a text not including named entities to the learning target model in a state where the first embedding layer and the second embedding layer are initialized to perform third pre-training.

14. The information processing method according to claim 13,
wherein the transformer layer includes a multi-head attention and a fully connected layer.

15. The information processing method according to claim 13,
wherein the learning target model includes a plurality of the transformer layers connected in series,
the second embedding layer is configured to linearly transform an output of the transformer layer in a final stage, and
the information processing method further comprising:
performing the third pre-training in a state where the weight parameters of each of the plurality of transformer layers are fixed, when it is determined that the end condition is satisfied in the third pre-training.

16. The information processing method according to claim 13, further comprising:
determining whether the end condition is satisfied based on a magnitude of a loss of the learning target model caused by the second pre-training or a predetermined number of times of the second pre-training.

17. The information processing method according to claim 16, further comprising:
determining that the end condition is satisfied when a loss of the learning target model caused by the second pre-training falls below a predetermined value.

18. The information processing method according to claim 13,
wherein the learning target model is a decoder-only model that does not include an encoder and includes a decoder, or an encoder-decoder model that includes the encoder and the decoder.

19. The information processing method according to claim 18,
wherein the learning target model includes the first embedding layer and the transformer layer that are separate from each other for the encoder and the decoder, and
the method further comprising:
performing the first pre-training, the second pre-training, and the third pre-training in both the encoder and the decoder in parallel.

20. The information processing method according to claim 13,
wherein, when a text input to the first embedding layer includes a content including named entities after the third pre-training is performed, the learning target model is configured to output an answer according to the content.
